(19) United States
(12) Patent Application Publication
(10) Pub. No.: US 2008/0065315 A1
(43) Pub. Date: Mar. 13, 2008

(54) Associating Location Information with Forensic Data

(76) Inventors: Gideon Guy, Chatsworth, CA (US); Eugenio Allevato, Northridge, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/530,423

(22) Filed: Sep. 8, 2006

(51) Int. Cl. G01C 21/00

(52) U.S. Cl. 701/200

(57) ABSTRACT

Associating location information with forensic data is disclosed. A location information module may include an antenna, a controller and a display. The location information module may be included in or be removably coupled to a forensic device, and may be removably coupled with a computing device or other device. The location information module may obtain location information from a location system such as a global position system (GPS) or other system. The location information module may prompt a user to remove the location information module from a forensic device, computing device or other device and instruct the user to go to a place with good reception. The location information may be transferred to the forensic device, computing device, or other device where it may be paired with forensic data, hard disk data and/or other data and/or information.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to obtaining information from or about storage devices and associating location information with the obtained information.

2. Description of the Related Art

Computers, portable digital assistants (PDAs), cellular telephones, portable music players (e.g., MP3 players), portable media players, and other computing devices have become ubiquitous in modern society. Students use computing devices for communicating with friends, professors and teachers; for writing computer software; for drafting papers; for taking notes; and for other purposes. Business people use computing devices for communicating with colleagues and clients; for writing documents; for preparing presentations; and for other purposes. The vast majority of people use computing devices for beneficial purposes. However, computing devices may also be put to malicious and nefarious uses. Criminals of all kinds use computing devices to further their goals. White collar criminals may use computing devices to steal private banking or financial information from companies and individuals. Sex offenders may use computing devices to view illegal pornography and entrap children and adults in illegal schemes. Terrorists may use computing devices to plan evil acts. Just as the list of beneficial uses of computing devices is endless, so is the list of malicious and nefarious uses.

Computing devices typically have a hard disk drive and/or other storage devices internal and/or external to the computing device. When a computing device is used for criminal purposes, evidence of the offender's criminal acts may be stored on a storage device included in or coupled with the computing device. Invenstigative agencies such as the police, secret service, district attorney, Federal Bureau of Invenstion and others may obtain an offender's computing device as evidence of criminal activity. In such circumstances, a forensic device may be used to copy information from and/or examine evidence included on the storage devices included in or coupled with the computing devices. The forensic device may be used in the field or at a premises outside of a forensic laboratory. A record of the evidence obtained may be created using an approved forensice device, such as, for example, the Talon® forensic device and MD5™ forensic device available from Logicube, Inc. of Chatsworth, Calif. A record of pertinent information about the computing device and/or the storage device may be preserved as of the time the computing device and/or storage device was taken into evidence and/or while the invenstigator evaluate the contents of the computing device and/or the storage device.

### DESCRIPTION OF THE DRAWINGS

FIG. 1 is a block diagram of an environment showing devices involved in an embodiment of associating location information with forensic data described herein.

FIG. 2 is a block diagram of an embodiment of a location information module described herein.

FIG. 3 is a flow chart of some of the actions taken by an embodiment of a location information module described herein.

FIG. 4 is a flow chart of additional actions taken by an embodiment of a location information module described herein.

FIG. 5 is a flow chart of actions taken by an embodiment of a forensic device described herein.

### DETAILED DESCRIPTION

Throughout this description, the embodiments and examples shown should be considered as exemplars, rather than limitations on the apparatus and methods disclosed or claimed.

In the investigation of crimes or other malfeasance, a forensic device may be used to copy information from and/or examine evidence included on storage devices included in or coupled with computing devices. The forensic device may be used in the field or at a premises outside of a forensic laboratory. The copy of information and/or a record of the evidence obtained may be created using an approved forensic device, such as, for example, the Talon® forensic device and MD5™ forensic device available from Logicube, Inc. of Chatsworth, Calif. The systems, devices and methods described herein provide for the capturing of location information and time information corresponding to the location and time data was obtained from a storage device and/or when and where an evidentiary record was created using a forensic device. The systems, devices and methods described herein provide for the capturing of location information and time information described herein may also be applied to the acquisition of images and/or sound using cameras, video recorders and/or audio recorders. The location information and/or time information may be used to detect fraud or to verify the authenticity of captured data.

Devices

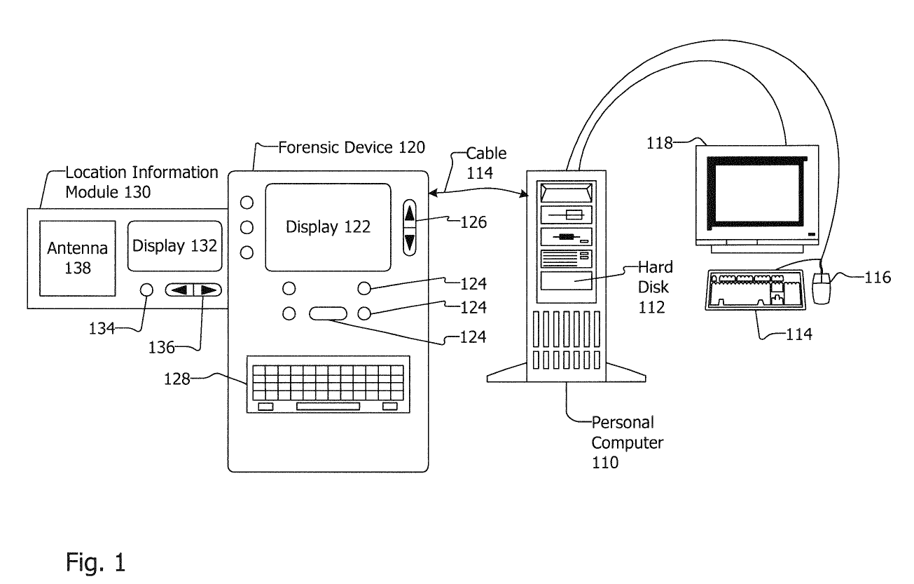

FIG. 1 is a block diagram of an environment showing devices involved in an embodiment of associating location information with forensic data. In one embodiment, the environment includes a forensic device 120 removably coupled with a personal computer 110 and a location information module 130 removably coupled with the forensic device 120. In other embodiments, the personal computer 110 is another computing device. As used herein, the term “removably coupled” means capable of being attached, connected, coupled, removed, disconnected, decoupled, reconnected, re-coupled, and/or re-attached.

The term “computing device” as used herein refers to any device with a processor, memory and/or a storage device that may execute instructions including, but not limited to, personal computers, server computers, computing tablets, set top boxes, video game systems, personal video recorders, voice over Internet protocol (VOIP) telephones, analog telephones, digital telephones, mobile telephones, cellular telephones, personal digital assistants (PDAs), portable media players, portable audio players (including MP3 players), portable computers, notebook computers, and laptop computers. These computing devices may run an operating system, including, for example, variations of the Linux, Unix, MS-DOS, Microsoft Windows, Palm OS, Symbian, and Apple Mac OS X operating systems.

In other embodiments, the hard disk 112 is another storage device. Although a hard disk 112 is shown, the techniques may be implemented with other storage media and/or other storage devices included with or otherwise coupled or attached to a computing device. These storage media include, for example, magnetic media such as hard disks, floppy disks and tape; optical media such as compact disks (CD-ROM and CD-RW) and digital versatile disks (DVD and DVD±RW); flash memory cards; and any other storage media. As used herein, a storage device is a device that allows for reading and/or writing to a storage medium. Storage devices include, hard disk drives, DVD drives, flash memory devices, and others. As used herein, the term storage device may include or be a storage medium. This is particularly so in the case of transportable flash memory devices which are often referred to as thumb drives, pen drives, pocket drives and jump drives.

In another embodiment, the location information module 130, although shown and described as removably coupled with the forensic device 120, is permanently coupled or otherwise included internal to the forensic device 120. In another embodiment, the location information module 130 is coupled with a portable computer or other portable computing device such as, for example, a cellular telephone or a PDA.

The forensic device 120 may allow for the acquisition of data from storage devices included in and/or coupled with the personal computer 110, such as hard disk 112. The forensic device 120 and/or an attached device coupled between the personal computer 110 and the forensic device 120 may restrict information flow to be exclusively from the personal computer and/or its associated storage devices to the forensic device 120. The forensic device 120 may be, for example, the TALON® forensic device and MD5™ forensic device available from Logicube, Inc. of Chatsworth, Calif. The forensic device 120 may be coupled to personal computer 110 via a cable 114.

The forensic device 120 may allow a user to copy data from a storage device such as hard disk 112 from a suspect's personal computer 110 to a storage device such as a hard disk included in forensic device 120. The copy made by the forensic device onto its internal hard drive may be authenticated, verified and/or otherwise guaranteed to be sufficient for use as evidence in a court of law. A verification, authentication or other record may be stored with or associated with the copied data. The forensic device 120 may allow a user to analyze data from a storage device such as hard disk 112 include in a suspect's personal computer 110 and produce a verified, authenticated or otherwise guaranteed record of the analyzed results to a storage device such as a hard disk included in the forensic device 120.

Cable 114 may be a Universal Serial Bus (USB) cable, an IEEE 1394 (more commonly known as a FIREWIRE®) cable, or may conform to another data transfer standard, including, but not limited to the Advanced Technology Attachment (ATA), ATA Packet Interface (ATAPI), serial ATA, Integrated Drive Electronics (IDE), Enhanced IDE (EIDE), small computer system interface (SCSI), Personal Computer Memory Card International Association (PCMCIA), Fibre Channel, Ethernet/IEEE 802.3, and their variants. In addition, wireless communications may be used to couple forensic device 120 to personal computer 110. The wireless communications may conform to a well known standard or protocol, including, for example, IEEE 802.11 (also known as Wi-Fi), IEEE 802.16, Bluetooth, and others.

The hard disk 112 and the hard disk included in the forensic device 120 may be formatted according to a well known standard, such as, for example, the File Allocation Table 16 bit (FAT-16), FAT-32, new technology file system (NTFS), Hierarchical File System (HFS) formats, and others. The format of the hard disk 112 and the hard disk included in the forensic device 120 may be the same or may be different.

The forensic device 120 may include display 102 and control buttons 124, scroll buttons 126, indicator lights (not shown), speaker (or other sound emitter) (not shown), key pad, partial or full keyboard 128, and other user interface devices. Display 102 may be a liquid crystal display (LCD) or other display.

The forensic device 120 may include various connectors to allow for connections to, coupling with and sending and receiving communications with computing devices. The connectors may provide support for various parallel, serial and other communications, including, for example, one or more of USB, IEEE 1394, SATA, IDE, RAID, Ethernet, IEEE 802.3, and others. The forensic device 120 may be capable of wireless communications with personal computer 110 and other computing devices via WiFi 802.11, Bluetooth and other wireless protocols.

The location information module 130 may be removably coupled with the forensic device 120 via a well known or proprietary connector. Generally, the location information module 130 provides location information in the form of geographical coordinates, namely, latitude and longitude, to the forensic device to which it is coupled. The location information may also include a current time, current date, elevation, user acceleration, user speed, and other data. A street address may also be calculated or obtained and included with the location information. The location information may also include a precision designation and/or information about the accuracy of the location information such as the estimated positioning error (EPE). The location information may be obtained from satellites that are part of the global positioning system (GPS). The location information may be obtained using the Wide-Area Augmentation System (WAAS). The location information module 130 may be capable of obtaining location information using one or more location systems, including, GPS, WAAS, Global Navigation Satellite System (GLONASS), European Geostationary Navigation Overlay System (EGNOS), Galileo, Doppler Orbitography and Radio-positioning Integrated by Satellite (DORIS), and Beidou.

The location information module 130 may have a display 132. The display 132 may be used to display the location information, strength of signal bars, elevation, timestamp, current time, countdown timer information (as discussed below), user interface information, instructions, and other information. In one embodiment, the display 132 is an organic light-emitting diode (OLED). The display 132 may be another kind of light emitting diode (LED), an LCD, or other display.

The location information module 130 includes an antenna 138. The antenna may be an active patch antenna. The antenna 138 may be an antenna capable of receiving location data from multiple satellites that are part of GPS and/or other location system. The location information module 130 may include one or more control buttons 134, a scroll button/wheel 136, status indicator lights (not shown), and/or a speaker or other sound emitter (not shown).

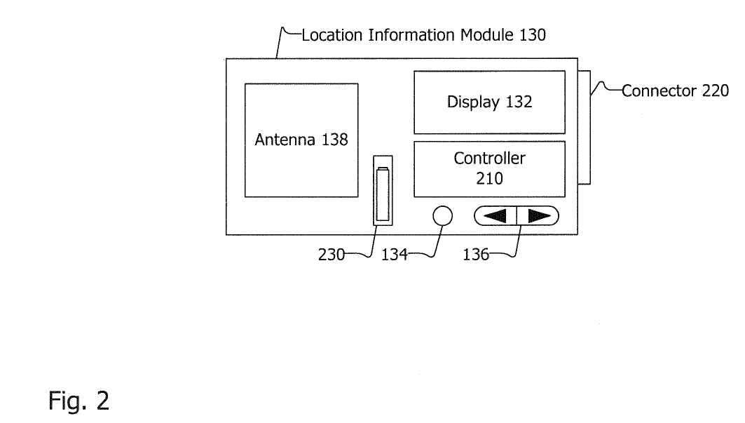

FIG. 2 is a block diagram of an embodiment of location information module 130 showing a controller 210, connector 220, and battery/battery compartment 230, in addition to the display 132, antenna 138, control button 134, and scroll button/wheel 136 discussed above. The location information module 130 may also have or include memory and a processor.

The location information module 130 may be removably coupled with the forensic device 120 via corresponding male and female communications connectors. In one embodiment, the location information module 130 includes a male DB-25 connector 220. In this embodiment, the location information module 130 is removably coupled with the forensic device 120 via a corresponding female DB-25 connector 220 included in the forensic device 120. In other embodiments, the connector 220 allows for connections to, coupling with and sending and receiving communications with forensic device 120, computing devices, cameras, video cameras and audio recorders. The connector 220 may provide support for various parallel, serial and other communications, including, for example, one or more of USB, EEE 1394, SATA, IDE, RAID, Ethernet, IEEE 802.3, and others. The location information module 130 may be capable of wireless communications with forensic device 120, computing devices, cameras, video cameras and audio recorders via WiFi 802.11, Bluetooth and other wireless protocols.

The location information module 130 may include a controller 210. The controller 210 may include or be one or more chips, components or other hardware and/or firmware that allow the location information module 130 to obtain location information from a satellite location system, communicate with the forensic device 120, and provide other features described herein. The controller 210 may be implemented on or as one or more logic arrays, memories, analog circuits, digital circuits, software, firmware, and processors such as microprocessors, microcontrollers, electrically erasable programmable read-only memory (EEPROM), field programmable gate arrays (FPGAs), application specific integrated circuits (ASICs), programmable logic devices (PLDs) and programmable logic arrays (PLAs). In one embodiment, the controller 210 may be implemented in part using a u-blox TIM-LH or TIM-4H available from u-blox America, Inc. of Herndon, Va. and an EEPROM.

The location information module 130 may include a battery/battery compartment 230. The battery/battery compartment 230 may provide power to one or more components included in the location information module 130, including the display 132, the controller 210, and the antenna 138. In one embodiment, the battery/battery compartment 230 is/is capable of holding a AA 3.6 volt battery.

Methods

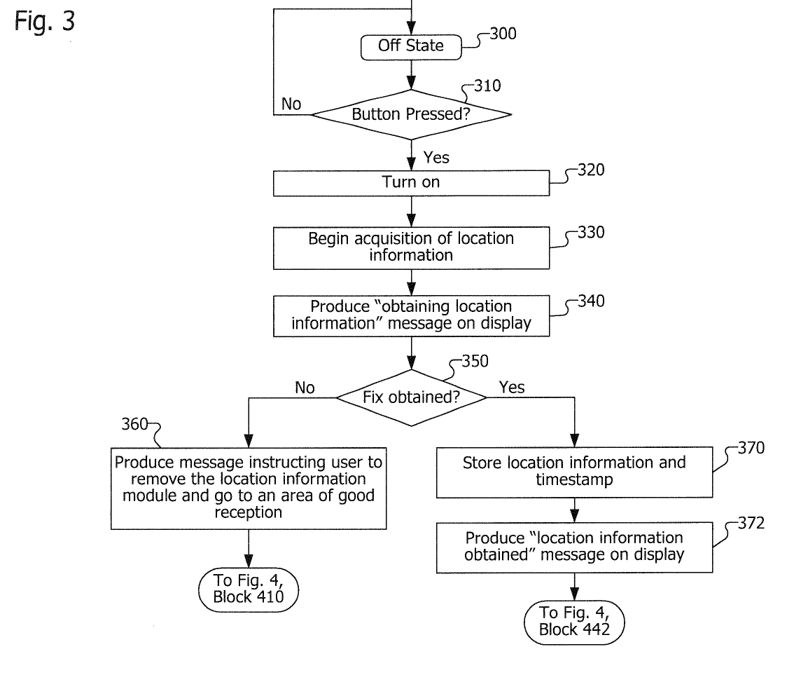

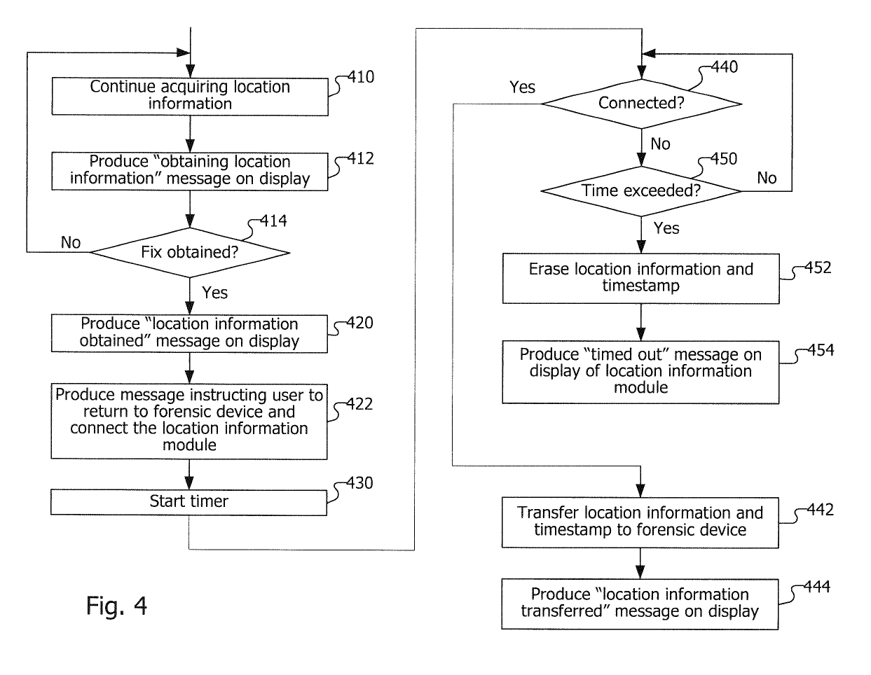

FIG. 3 is a flow chart of the actions taken by an embodiment of a location information module, and FIG. 4 is a flow chart of additional actions taken by an embodiment of a location information module. In one embodiment, the actions described in FIGS. 3 and 4 may be performed by location information module 130 that is removably coupled with a forensic device 120 as shown and described regarding FIGS. 1 and 2. In another embodiment, the actions described in FIGS. 3 and 4 may be performed by a location information module 130 that is removably coupled with a computing device, such as, for example, a PDA, cellular telephone or portable computer, or with a camera, video camera or audio recorder. In yet another embodiment, the actions described in FIGS. 3 and 4 may be executed by a location information module implemented in a combination of some of software, firmware, an antenna, an EEPROM, an FPGA or other PLD, thereof included in a forensic device such as forensic device 120 shown in FIG. 1 which may be, for example, the Talon® forensic device and MD5™ forensic device available from Logicube, Inc. of Chatsworth, Calif.

Referring now to FIG. 3, the method begins in an off state, as shown in block 300. A check is made to determine whether a start button or other button has been pressed to start the process of obtaining location information, as shown in block 310. In another embodiment, a start command may be received either by the pressing of a button or other user or software input. If a button has not been pressed or if a command has not been received, the method remains in the off state, block 300. If a button has been pressed or if a command has been received indicating or initiating the obtaining of location information, the removably attached location information module turns on, as shown in block 320. When an embodiment includes a location information module included internal to a forensic device, the components needed to obtain the location information may be turned on, such as, for example, an antenna.

The acquisition of location information begins, as shown in block 330. Location information may be obtained from one or more location systems (defined above) according to techniques known to those skilled in the art, including trilateration, using four or more satellites for increased accuracy, and the like. An “obtaining location information message” may be produced on a display included in a location information module or in a forensic device, as shown in block 340. The “obtaining location information message” may include timing information such as the time the attempt to obtain location information began, and how much time remains in a system defined maximum amount of time. In various embodiments, the system defined maximum amount of time may be 5, 7, 10, 12, 15, etc. minutes. The “obtaining location information message” may include countdown or count up information related to the system defined maximum amount of time. The “obtaining location information message” may include an indication of the current strength or accuracy of the location information as it is being obtained.

A check is made to determine if a sufficiently accurate location fix has been obtained, as shown in block 350. A sufficiently accurate location fix may occur when coordinates within better than 20 meters is achieved. In various embodiments, the accuracy may be set at other distances, such as, for example, 10 meters, 30 meters, 50 meters, quarter mile, half mile and others. When a sufficiently accurate location fix has been obtained, as shown in block 350, the location information is stored along with timestamp information, namely the time and date the location information was obtained, as shown in block 370. The timestamp may be time information received with the location information from a location system. A “location information obtained” message may be produced on the display of the location information module or on a display of the forensic device or other computing device, as shown in block 372. The “location information obtained” message may include a general statement of success, the location information and the timestamp. A street address may also be calculated or obtained and included with the location information. The flow of actions continues at block 442 of FIG. 4, discussed below.

When a sufficiently accurate location fix has not been obtained, a message instructing the user to remove the location information module and go to an area of good, or at least sufficient, reception may be produced, as shown in block 360. When the location information module is not removably attached to a forensic device or computing device but is permanently installed in a forensic device or portable computing device (such as, for example, a notebook computer, PDA, etc.), the message may prompt the user bring the forensic device or portable computing device to a location with good, or at least sufficient, reception. The flow of actions continues at block 410 of FIG. 4, discussed below.

Referring now to FIG. 4, when a fix cannot initially be obtained, the method continues attempting to acquire sufficiently accurate location information, as shown in block 410. An “obtaining location information message” may be produced (as described above) on a display included in a location information module (and/or in a forensic device), as shown in block 412. A check is made to determine if a sufficiently accurate location fix has been obtained, as shown in block 414. When a sufficiently accurate location fix has not yet been obtained, as shown in block 414, the flow of actions returns to block 410, as described above. When a sufficiently accurate location fix has been obtained, as shown in block 414, a “location information obtained” message (described above) may be produced on the display of the location information module (or on a display of the forensic device or other computing device), as shown in block 420. Another message may also produced on the display of the location information module instructing the user to return to the forensic device (or computing device) and connect the location information module, as shown in block 422.

As shown in block 430, a timer in the location information module may be started after the location information has been obtained when a location information module is disconnected from the forensic device. The timer may expire when a system defined maximum amount of time is reached. In this way, a user may be provided with a system defined amount of time or time limit to return to the forensic device (or other computing device) and reconnect the location information module. The flow of actions continues with moving between checking to evaluate whether the location information module is connected to a forensic device or other computing device, as shown in block 440, and checking whether the timer in the location information module has exceeded the system defined maximum amount of time, as shown in block 450. That is, a check may be made to determine whether the user has exceeded the time limit provided to connect the location information module to the forensic device or other computing device. The timer may expire when a system defined maximum amount of time is reached. In this way, a user is given a system defined maximum amount of time, a time limit, to move to a location of good reception to obtain location information to be associated with a forensic record already obtained and stored on a forensic device. A user may be provided with a system defined amount of time or time limit to leave a present location and find a location with sufficient access to location system satellite signals. For example, the system defined amount of time or time limit may be an amount of time to allow for a user to walk from an internal room to an external room, or move from a basement to a lobby or other above ground level floor, etc. In various embodiments, the system defined maximum amount of time or time limit may be 5, 7, 10, 12, 15, 18 etc. minutes.

When the location information module is connected to a forensic device, as shown in block 440, the location information and its timestamp are transferred to the forensic device or to the computing device, as shown in block 442. In another embodiment, when a location information module is permanently included in a forensic device, the location information and its timestamp are transferred to another module or component included in the forensic device. The forensic device or computing device may then associate, pair, or otherwise couple the location information and timestamp with a forensic record, with hard disk drive data copied from a suspect device, or other with information. The location information and/or its associated timestamp may be used as part of a chain of custody, to provide proof of the time and location of the obtaining of hard disk or other data, and/or for other investigatory and legally pertinent purposes. The location information may be used to verify the location of acquisition of the information on a hard disk using a forensic device. As such, the location information module may be used to confirm the veracity of acquisition of information from a hard disk at a particular location.

In another embodiment, when a location information module is plugged into or attached to another device such as a camera, video camera, audio recorder or other device, the location information and/or its associated timestamp may be used to verify the accuracy of the date and time of recordation of images and/or sound and the location of capturing of the images and/or sound. In this way, the location information module may be used as a fraud detection device or a data (including hard disk drive data, sound, and/or images) verification device.

A “location information transferred” message may be produced on the display of the location information module (and/or on a display of the forensic device or other computing device), as shown in block 444. The “location information transferred” message may include a general statement of success, the location information, the timestamp, and/or information about the accuracy of the location information.

When the timer in the location information module has exceeded the system defined maximum, as shown in block 450, that is, the time limit has expired, the location information and its associated timestamp are erased, as shown in block 452, and an “attempt timed out” message is produced on the display of the location information module (and/or in a forensic device or other computing device in which the location information module is included or removably coupled), as shown in block 454.

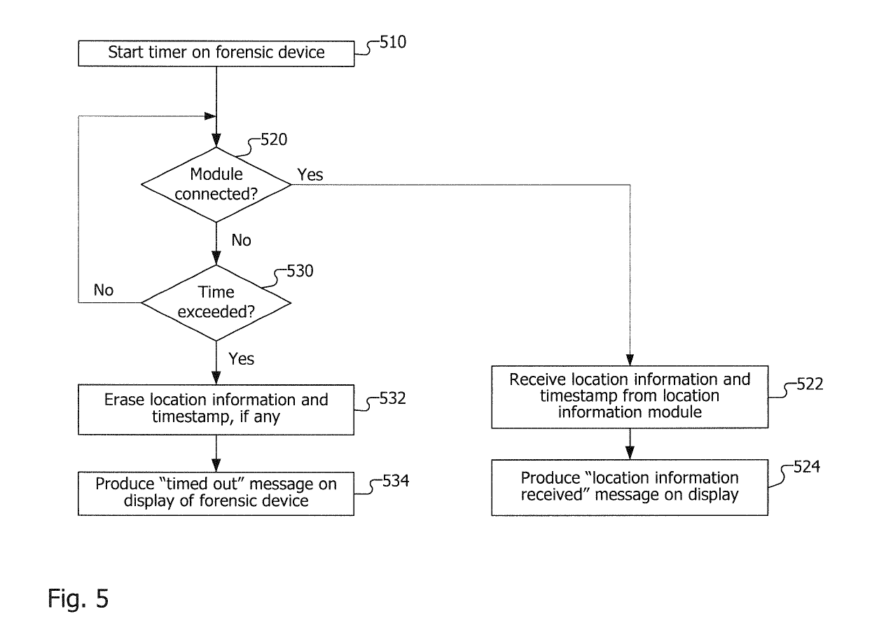

In one embodiment, a timer may also be included in the forensic device to which the location information module is removably coupled. FIG. 5 is a flow chart of actions taken by an such an embodiment of a forensic device. When the location information module is removably coupled with a forensic device, the forensic device may include a timer that calculates a round trip time that provides the user a system defined period of time to remove the location information module, proceed to a place with good reception, obtain location information, return to the forensic device, and connect the location information module to the forensic device. The forensic device timer time limit may be a system defined amount of time, such as, as, for example, 10, 12, 15, 16, 20, 23, 25, 28, 30, 33, etc. minutes.

Referring now to FIG. 5, a timer of the forensic device may be started, as shown in block 510. The starting of the timer may occur when the location information module is removed from the forensic device. A check may be made to learn whether the location information module is connected to the forensic device, as shown in block 520. When the location information module is discovered to be connected to the forensic device, the forensic device receives location information and a timestamp from the location information module, as shown in block 522. The forensic device may produce a “location information received” message on its display, as shown in block 524.

When the location information module is not connected to the forensic device, as shown in block 520, a check may be made to determine if the attempt to obtain location information has timed out by evaluating whether the timer has exceeded the system defined maximum, as shown in block 530. That is, a check may be made to determine whether the user has exceeded the time limit provided by the forensic device to obtain location information.

When the timer has exceeded the system defined maximum or the allotted time has been exceeded, as shown in block 530, location information and its associated timestamp are erased, if any were obtained, as shown in block 532, and an “attempt timed out” message is produced on the display of the forensic device in which the location information module is removably coupled, as shown in block 534. When the timer has not exceeded the system defined maximum, as shown in block 530, the flow of actions returns to block 520 to evaluate whether the location information module ha been returned, replaced, reconnected, etc.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, whether in the written description or the claims, “plurality” means two or more.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the written description and in the claims does not by itself connote any priority, precedence, or order of one unit, item, or claim element over another or the temporal order in which acts of a method are performed, but are used merely as labels to distinguish one unit, item, and claim element having a certain name from another element having a same name, but for use of the ordinal term. As used herein, “and/or” means that the listed items are alternatives, but the alternatives also include any combination of the listed items.

1. A location information module comprising:
an antenna;
a connector;
a controller;
the location information module configured to:
acquire location information and time information from a location system,
transfer the location information and the time information to a forensic device.

2. The location information module of claim 1 wherein the location system is at least one of global positioning system (GPS), Wide-Area Augmentation System (WAAS), Global Navigation Satellite System (GLONASS), European Geostationary Navigation Overlay System (EGNOS), Galileo system, Doppler Orbitography and Radio-positioning Integrated by Satellite (DORIS) system, and Beidou system.

3. The location information module of claim 1 further configured to:
when the location information cannot initially be obtained
prompt a user to remove the device from the forensic device; and
instruct the user to go to a place with good reception.

4. The location information module of claim 3 further configured to:
check whether the device is connected to a forensic device
check whether a time limit has been exceeded
perform the transfer when the device is connected to the forensic device and when the time limit has not been exceeded.

5. The location information module of claim 4 further configured to:
erase the location information when the time limit has been exceeded.

6. A forensic device, the forensic device augmented with a location information module,
the location information module configured to:
acquire location information and time information from a location system;
transfer the location information and the time information to the forensic device.

7. The forensic device of claim 6 wherein the location system is at least one of global positioning system (GPS), Wide-Area Augmentation System (WAAS), Global Navigation Satellite System (GLONASS), European Geostationary Navigation Overlay System (EGNOS), Galileo system, Doppler Orbitography and Radio-positioning Integrated by Satellite (DORIS) system, and Beidou system.

8. The forensic device of claim 6 wherein the forensic device associates the location information and timestamp with copied hard disk data.

9. The forensic device of claim 6 wherein the forensic device associates the location information and timestamp with a forensic record.

10. The forensic device of claim 6 further configured to:
prompt a user to remove the device from the forensic device when the location information cannot be obtained
instruct the user to go to a place with good reception when the location information cannot be obtained.

11. The forensic device of claim 10 further configured to:
check whether a time limit has been exceeded
perform the transfer when the time limit has not been exceeded.

12. The location information module of claim 11 further configured to:
erase the location information when the time limit has been exceeded.

13. The forensic device of claim 6 wherein the location information module includes an antenna and a controller.

14. The forensic device of claim 13 wherein the location information module is included internal to the forensic device.

15. The forensic device of claim 13 wherein the location information module is removably coupled with the forensic device.

16. The forensic device of claim 15 wherein the location information module is configured to:
acquire location information from a location system
transfer the location information and a timestamp to the forensic device.

17. The forensic device of claim 16 wherein the location information module is further configured to:
when the location information cannot initially be obtained
prompt a user to remove the device from the forensic device; and
instruct the user to go to a place with good reception.

18. The forensic device of claim 17 wherein the location information module is further configured to:
check whether the device is connected to the forensic device
check whether a time limit has been exceeded
perform the transfer when the device is connected to the forensic device and when the time limit has not been exceeded.

19. The forensic device of claim 18 wherein the location information module is further configured to:
erase the location information when the time limit has been exceeded.

20. A location information module comprising:
an antenna;
a connector;
a controller;
the location information module configured to:
acquire location information and time information from a location system,
transfer the location information and the time information to a device, wherein the device is selected from the group comprising a forensic device, personal digital assistant, a portable computer, a notebook computer, a camera, a video camera, and audio recording device.

21. The location information module of claim 20 wherein the location system is at least one of global positioning system (GPS), Wide-Area Augmentation System (WAAS), Global Navigation Satellite System (GLONASS), European Geostationary Navigation Overlay System (EGNOS), Galileo system, Doppler Orbitography and Radio-positioning Integrated by Satellite (DORIS) system, and Beidou system.

22. The location information module of claim 20 further configured to:
when the location information cannot initially be obtained, instruct the user to go to a place with good reception.

23. The location information module of claim 22 further configured to:
check whether a time limit has been exceeded
perform the transfer when the time limit has not been exceeded.
